(19) United States
(12) Patent Application Publication
(10) Pub. No.: US 2017/0186017 A1
(43) Pub. Date: Jun. 29, 2017

(54) SYSTEMS AND METHODS FOR PRODUCT WARRANTY REGISTRATION AND TRACKING

(71) Applicant: Wal-Mart Stores, Inc., Bentonville, AR (US)

(72) Inventors: Donald R. High, Noel, MO (US); Michael Dean Atchley, Springdale, AR (US); Charles Kaufman, Lowell, AR (US)

(21) Appl. No.: 15/384,630

(22) Filed: Dec. 20, 2016

Related U.S. Application Data
(60) Provisional application No. 62/387,541, filed on Dec. 24, 2015.

(51) Int. Cl. G06Q 30/00; G06Q 30/06; G06K 7/10; G06Q 20/20

(52) U.S. Cl. CPC G06Q 30/012; G06Q 20/202; G06Q 30/0633; G06K 7/10712

(57) ABSTRACT

Systems and methods are provided for registering an item under warranty, comprising: performing an item warranty registration that includes associating information about an item with information about a customer of the item; and using the information about the customer of the item for subsequent item warranty registrations.

### RELATED APPLICATIONS

This application claims priority to U.S. Provisional Patent Application No. 62/387,541, filed Dec. 24, 2015 and entitled “Systems and Methods for Product Warranty Registration and Tracking,” the entirety of which is incorporated by reference herein.

### FIELD

The present inventive concepts relate generally to warranty registrations, and more specifically, to the association of the purchase of a product and the registration of that product to receive warranty services so that other services may be offered.

### BACKGROUND

When commercial goods are sold, they are typically covered by a limited warranty. In order to activate a warranty, the purchaser is required to complete a warranty registration process, for example, online, which is separate and distinct from the purchase process, regardless of whether the purchase process occurs online or at a brick-and-mortar store.

### BRIEF SUMMARY

In one aspect, provided is a method for registering an item under warranty, comprising: performing an item warranty registration that includes associating information about an item with information about a customer of the item; and using the information about the customer of the item for subsequent item warranty registrations.

In some embodiments, the method further comprises creating and storing a record that includes the item warranty registration; associating information about an item with the information about the customer of the item; and adding the record to a list of registered items.

In some embodiments, the record is used to facilitate a future warranty registration.

In some embodiments, the method further comprises processing a combination of the information about the item and the information about the customer of the item to perform an automated warranty process on the item.

In some embodiments, the method further comprises storing customer item ownership information regarding purchases made by the customer; and using the customer item ownership information to track item sales and facilitate warranty claims.

In some embodiments, the method further comprises comparing warranty coverage information and actual event data to determine whether the registered item is covered by a warranty program.

In another aspect, provided is a warranty registration and tracking system, comprising: an interface to a third party system for performing services related to a warranty; and a processor that facilitates a communication between a personal electronic device and one or more data stores to perform an automated warranty process regarding the services related to the warranty on purchased store items using customer information stored at a data store of the one or more data stores.

In some embodiments, the interface communicates with a website or other third party system permitting the customer to perform a warranty registration process, and wherein the interface communicates with a point of sale (POS) system, web application, or other electronic device for automating the warranty registration process for application to additional warranty processes.

In some embodiments, the warranty registration and tracking system processes a combination of customer profile data stored at customer information data store of the data stores and credential data in a credential data store of the data stores to identify a customer of items to which one or more warranties apply.

In some embodiments, the warranty registration and tracking system includes a processor constructed and arranged to process a customer item warranty when a warranty is approved.

In some embodiments, the warranty registration and tracking system includes a processor constructed and arranged to validate warranty requirements.

In another aspect, provided is a system for automating a warranty process, comprising: a receipt scanning system; an automated warranty claims system; a third party warranty system; at least one data store; and a warranty registration and tracking system that processes data received from a combination of the receipt scanning system, the automated warranty claims system, and the third party warranty system to performing services related to a warranty.

In some embodiments, the warranty registration and tracking system creates from data a record that includes item warranty registration, associates information about an item with the information about the customer of the item, adds the record to a list of registered items, and stores the record at a data store of the at least one data stores.

In some embodiments, the record is used to facilitate a future warranty registration.

In another aspect, provided is a method for registering an item under warranty, comprising: purchasing, by a customer, a store item; receiving information about the customer of the store item; associating the customer information with information about the store item, the information including store item warranty information; creating and storing a record that includes the association between the store item; warranty information and the customer information; and using the record to facilitate a future warranty registration.

In some embodiments, the method further comprises offering additional services by associating the purchase information and the warranty registration.

In some embodiments, another warranty registration can be performed using the customer information in the record.

In some embodiments, the other warranty registration includes an extended warranty registration.

In some embodiments, the method further comprises ordering a replacement part for the store item using the record, wherein the ordering information is linked to the record.

In another aspect, provided is a method for automating a warranty process, comprising: registering a purchased store item for a warranty service; storing the initial warranty registration; creating and storing a record that includes the association between the initial warranty registration information and information about the purchaser of the store item; and performing another warranty registration using the record.

In some embodiments, registering the purchased store item for a warranty service comprises scanning a barcode at a cashier register or other location such as a doorway or basket or transferring standard warranty information through a smart device.

In some embodiments, registering the purchased store item for a warranty service comprises scanning RFID chips or optical recognition of the store items a barcode at a cashier register or other location such as a doorway or basket or transferring standard warranty information through a smart device.

### BRIEF DESCRIPTION OF THE SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts.

FIG. 1 is a diagram illustrating an environment in which embodiments can be practiced.

FIG. 2 is a flow diagram of a method for product warranty registration, in accordance with some embodiments.

FIG. 3 is a flow diagram of a warranty process, in accordance with some embodiments.

### DETAILED DESCRIPTION

Embodiments of the present inventive concepts include an automated warranty process, which is not offered as part of a conventional warranty registration process, and can retain information corresponding to the warranty of one item purchase for reuse for other purchases, effectively creating a data set or list of warranties managed by the customer. Modern warranty registration processes require a separate registration process for each item under warranty. Each item may fall under a different set of rules or policies pertaining to its corresponding warranty. This poses a burden on the consumer, who must keep track of different warranty information. In addition, it is difficult for one to know which items are potential replacements for items losing warranty protection without a significant effort on the part of the consumer. For example, most electronic devices such as smart phones, electronic notebooks, notepads, or other related personal computing devices require upgrades periodically.

Embodiments of the inventive concepts provide a solution that automatically connects via electronic devices communicating over the internet or other communication network the purchase of a product to the warranty registration of that product to receive warranty services. By associating and processing data from purchase processes and warranty registration processes, additional services can be offered that are otherwise not possible without the processes being connected such as automated warranty claims and management. For example, once a warranty item is registered in accordance with some embodiments, a warranty registration and tracking system can keep track of the items under the registration and be used to facilitate any warranty claims that the customer would like to make. An example of an operation of this feature may include providing information about a customer for registering a warranty for a purchased product, and which can be stored and saved for reuse with respect to other warranties.

Warranty-related functions may therefore be under customer control and accessible via any mode of contact including but not limited to point-of-sale, mobile applications, web browsers, text messaging, social media, and so on. In some embodiments, systems and methods allow a customer to control the items purchased, automates the warranty registration process, and facilitate warranty claims and management. A customer therefore may have increased personalization, visibility, and awareness of warranty coverage and is permitted to manage a warranty interaction in significantly less time than conventional offerings. Little or no human intervention may be needed due to the automatic features associated with these concepts.

Thus, inventive aspects may include but not be limited to an electronic method and customized computer processing of registering warranties, storage of electronic information for future reuse with other warranties, electronic interfacing with third party organizations for the registration of the warranty, electronic retrieval of warranty information from third party, storage of retrieved third party information on central computer servers, access, retrieval, and viewing of third party warranty information on smart device, web app, or point of sale (POS) for a customer, association of electronic receipt with warranty information for possible future return, replacement, or refund, and/or access to non-covered parts or associated non-covered items which can be purchased.

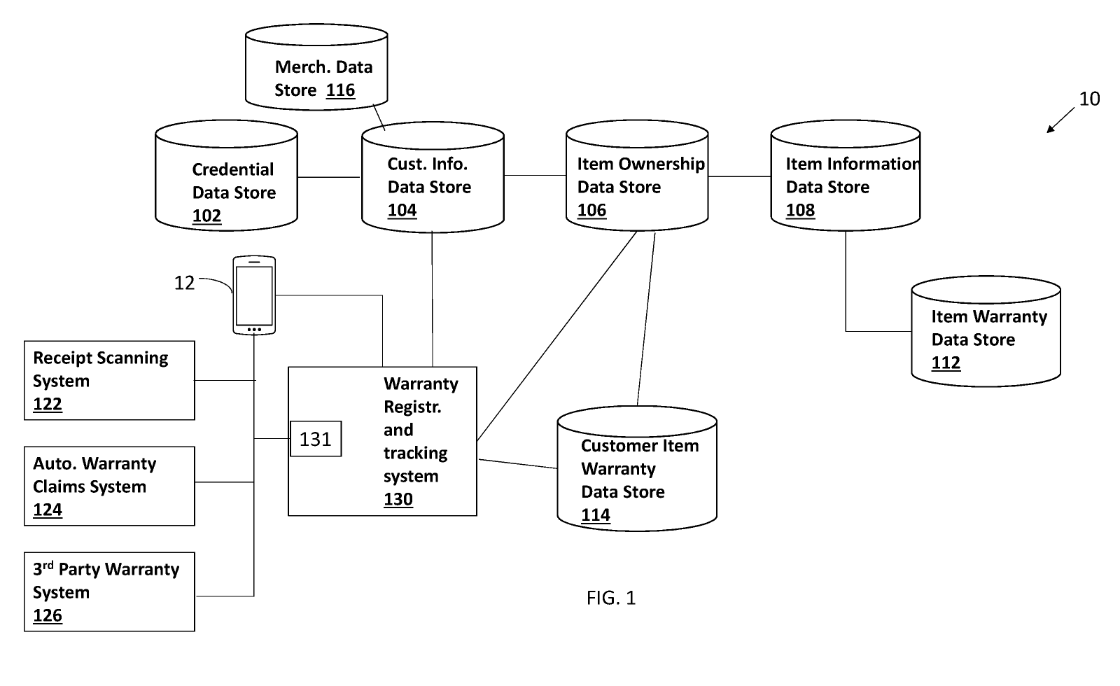

FIG. 1 is a diagram illustrating an environment in which embodiments can be practiced.

The environment 10 includes a plurality of data stores, which include but not limited to a credential data store 102, a customer information data store 104, a customer item ownership data store 106, an item information data store 108, an item warranty data store 112, a customer item warranty data store 114, and a merchandising data store 116. Some or all of the data stores may be accessed by a personal electronic device 12, for example, a smartphone, tablet, notebook, desktop computer, laptop computer, and so on. Some or all of the data stores may include a database or other repository of a data storage device. The environment 10 also includes a warranty registration and tracking system 130 that facilitates communications between the personal electronic device 12 and one or more or of the data stores 102-116, for example, to perform an automated warranty process on purchased store items using customer information. Some or all of the data stores 102-116 may communicate with each other and/or the personal electronic device 12 and the warranty registration and tracking system 130 may communicate with each other via a communications network, for example, a wired or wireless network. Relationships between the various data stores may be established by a customer identifier, such as membership identification.

The credential data store 102 stores customer credential data such as username, password, keys, encryption technology, and/or other identification or authentication credentials unique to the customer.

The customer information data store 104 stores customer profile data, such as customer personal information, for example, name, address, age, job title, history of purchased products, and so on. The customer information may be stored as text, voice, visual, biometric, or other form. A combination of customer profile data in the customer information data store 104 and credential data in the credential data store 102 can be processed by a warranty registration and tracking system 130 (described below) to identify a customer. In some embodiments, the customer profile data and credential data are stored at the same data store, for example, a common database, instead of separate data stores 102, 104.

The customer item ownership data store 106 stores customer item ownership data, for example, information regarding purchases made by a customer at the store. This data can be used to track item sales and facilitate warranty claims made by the customer. Customer item ownership data may be used to track facilitate warranty claims, for example, to track what items the customer owns and various history related to the item purchased.

The item information data store 108 stores item data, in particular, data pertaining to store items, such as model number, specifications, images, nutritional data, and so on.

The item warranty data store 112 stores item warranty data. Store item warranty data can include details on what a particular warranty covers, and doesn't cover with respect items, for example, corresponding to item information stored at the item information data store 108. Other warranty data can include component-level warranties, such as powertrain warranty on a car, disclaimers on coverage, and so on.

The customer item warranty data store 114 stores customer item warranty data. Customer item warranty data may include information specific to a warranty that exists on an item purchased by the customer. For example, item warranty data may indicate that a warranty is offered on a product sold by the store, for example, 12 month bumper to bumper warranty. Customer item warranty data, on the other hand, may refer to an amount of warranty left on a purchased item, for example, 3 months of a 12 month warranty. The customer item warranty data store 114 and/or item warranty data store 112 may be accessed by a customer's computer, for example, smartphone, electronic notebook, and so on, to establish what items are under warranty, and details related to those warranties.

The merchandising data store 116 may store data regarding a customer's inventory, which may include items that are owned by a customer but not under warranty. Accordingly, a customer can view all customer assets by accessing a combination of the merchandising data store and the customer item warranty data store 114.

Stored and executed at the personal electronic device 12 may include applications that are stored and executed at the device 12, and when executed can communicate with a receipt scanning system 122, an automated warranty claims system 124, and a third party warranty system 126, respectively. A camera of the electronic device 12 can capture an image, while a combination of the receipt scanning system 122 and automated warranty claims system 124 can process the image, for example, to interpret it. The third party warranty system 126 can be viewed from the electronic device 12, for example, via an internet connection. In some embodiments, the customer's smartphone or other personal computing device may include a built-in scanning feature, for scanning a barcode and as a result transferring warranty registration via the electronic device.

The receipt scanning system 122 may process scanned purchase receipts, which can include information that is combined with warranty information by the warranty registration and tracking system 130. Data retrieved by the scanning system 122 such as purchase date, price, and so on may be stored at the customer item ownership data store 106. Upon scanning a purchase receipt, the item information is communicated to the tracking system 130. Items for registration can be selected and processed with respect to warranty-related services.

The automated warranty claims system 124 can facilitate the registration of warranty items using customer information stored at the data stores 102, 104. In doing so, a customer may register by entering credentials, or otherwise signs on. Once signed on, the customer can view an asset list, or perform other warranty maintenance. For example, an item list or the like can be retrieved from the ownership data store.

The third party warranty system 126 stores data related to warranty claims, which can be retrieved for processing by other elements of the environment 10 for processing.

As described above, the warranty registration and tracking system 130 is configured to process data in the credential data store 102 and the customer information data store 104, respectively, to identify a customer so that a warranty process can be applied automatically to items purchased by the identified customer. The warranty registration and tracking system 130 also registers or otherwise processes a customer item warranty when the warranty is approved. This can be achieved at a checkout register. A customer may register with a cashier in cases where an extended warranty is or various warranty options are offered. The cashier may ask if the customer wants to purchase the extended warranty, and submit the customer's response electronically. The warranty registration and tracking system 130 can maintain a list of registered items under warranty. The list can be stored and maintained as part of a database structure or the like for subsequent retrieval via a network connection from an electronic device. From this list, if an item fails under warranty, the warranty registration and tracking system 130 can initiate a refund or replacement of the item, look at accessories related to the failed item, for example, a grill cover for a grill that is returned under warranty, view the value of items under warranty, link to parts ordering, and so on.

Once a warranty item is registered in accordance with some embodiments, the warranty registration and tracking system 130 can keep track of the items under the registration and be used to facilitate any warranty claims that the customer would like to make. For example, the facilitation of a warranty claim may include a basic determination of warranty coverage. For example, a warranty policy may include coverage details. The system 130 can compare warranty coverage information to actual event data, for example, to determine whether an item registered under the warranty program is covered. Accordingly, potential replacement items can be identified and displayed, for example, at the customer device 12. Other information such as comparative warranty information may also be provided. For example, information may include comparative information regarding a warranty to purchase extended warranty for 1 year for $100, or a 2 year option for $150.

The warranty registration and tracking system 130 can also generate alerts, for example, when items exceed a warranty timeframe.

In some embodiments, the warranty registration and tracking system 130 includes an interface 131 between the third party warranty system 126 and the customer device 12 for automating the warranty process. For example, a customer may fill out a registration card displayed electronically on a computer display screen, and by entering personal data at a user interface in communication with a website. This data can be used as part of an automatic registration process for warranty-related registrations. The interface may also communicate with a point of sale (POS) system, web application, or other electronic device for automating the warranty process in accordance with embodiments herein.

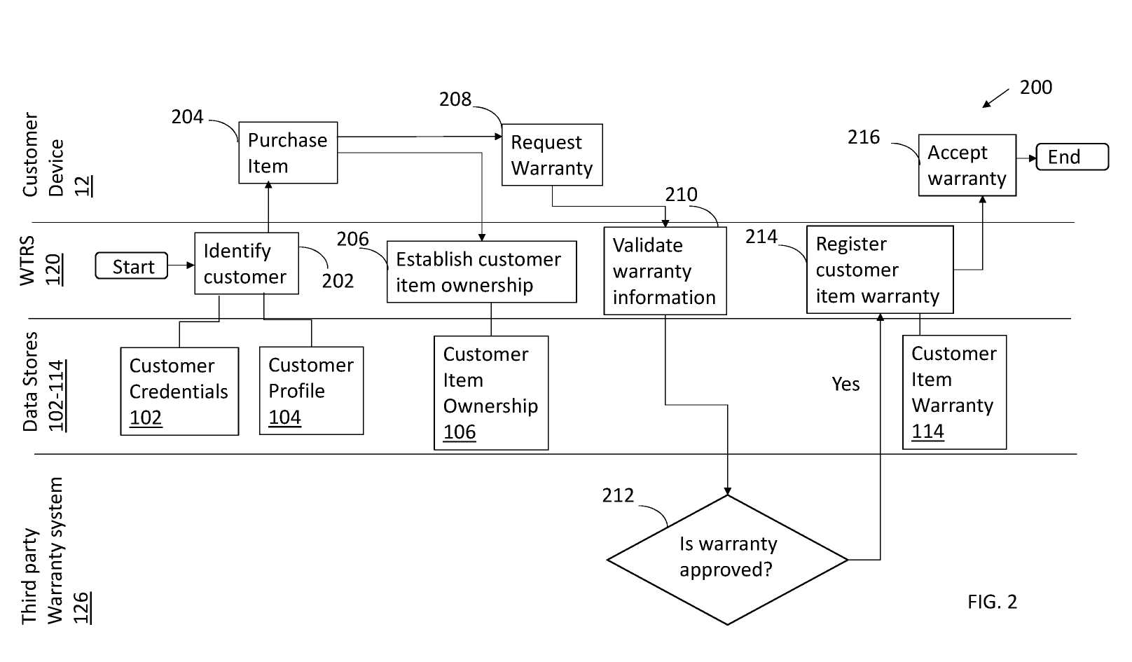

FIG. 2 is a flow diagram of a method 200 for product warranty registration, in accordance with some embodiments. Some or all of the method 200 can be performed at the warranty registration and tracking system (WRTS) 130 of FIG. 1, and/or other elements of the environment illustrated in FIG. 1. The method 200 can be governed by instructions that are stored in a memory device of the warranty registration and tracking system 130 of FIG. 1, and/or other elements of the environment illustrated in FIG. 1, and executed by a hardware processor of the warranty registration and tracking system 130 of FIGS. 1 and 2, and/or other elements of the environment illustrated in FIG. 1.

At step 202, the warranty registration and tracking system 130 processes data from the credential data store 102 and the customer information data store 104, respectively, so that the customer is known at the time of a purchase. If the customer is not identified at step 202, then customer information can be provided, for example, via text, voice, visual, biometrics, or other form, and stored at the customer information data store 104. The customer may also complete an online application or related form to create credentials such as a username and password, biometric information, or other online security-related information which can be stored at the credential data store 102.

At step 204, the identified customer can use a personal electronic device 12 to purchase an item. At block 206, the warranty registration and tracking system 130 can establish a relationship between the identified customer and the item(s) purchased by the customer, by receiving purchase data from the customer's personal electronic device 12, which may purchase the item(s) by scanning the item, interacting with a point of sale system, and so on, and by comparing the received purchase data to contents of the credential data store 102 and/or the customer information data store 104.

At step 208, the customer requests that a warranty be provided for the purchased item(s), which can be automatically generated using the stored customer information. An inquiry can be generated and displayed, whereby the customer can respond by entering “yes” electronically indicating that the customer desires to register the item for a warranty package. Instead of requiring an independent warranty registration process, the warranty registration and tracking system 130 uses the customer information to associate with item warranty information.

At step 210, the warranty registration and tracking system 130 validates the warranty requirements. Some items may have certain restrictions for warranty, for example, if the item is purchased on sale or as part of a clearance, for example, or in another example, if the customer is required to purchase another item for the particular warranty offering.

At decision diamond 212, the warranty is approved or denied by the third party warranty system 126. For example, a warranty may be denied due to a restriction, where details or data may be stored in the third party warranty system 126. For example, a user may be required to purchase four tires in order for a warranty to be approved.

At step 214, the customer item warranty is registered if the warranty at decision diamond 212 is approved. As described above, a customer can register with a cashier or by scanning a barcode and transferring standard warranty info through the smart device. If the retrieved customer identifier is known, and the customer makes a request, then the cashier can initiate a warranty process. Alternatively, the customer may scan the receipt or the item UPC to initiate the registration process. Warranties can be tracked/added through the scanning of a receipt (if the purchase was anonymous or ambiguous) automatically.

At step 216, the warranty is accepted, for example, an electronic acceptance is executed at the customer device 12.

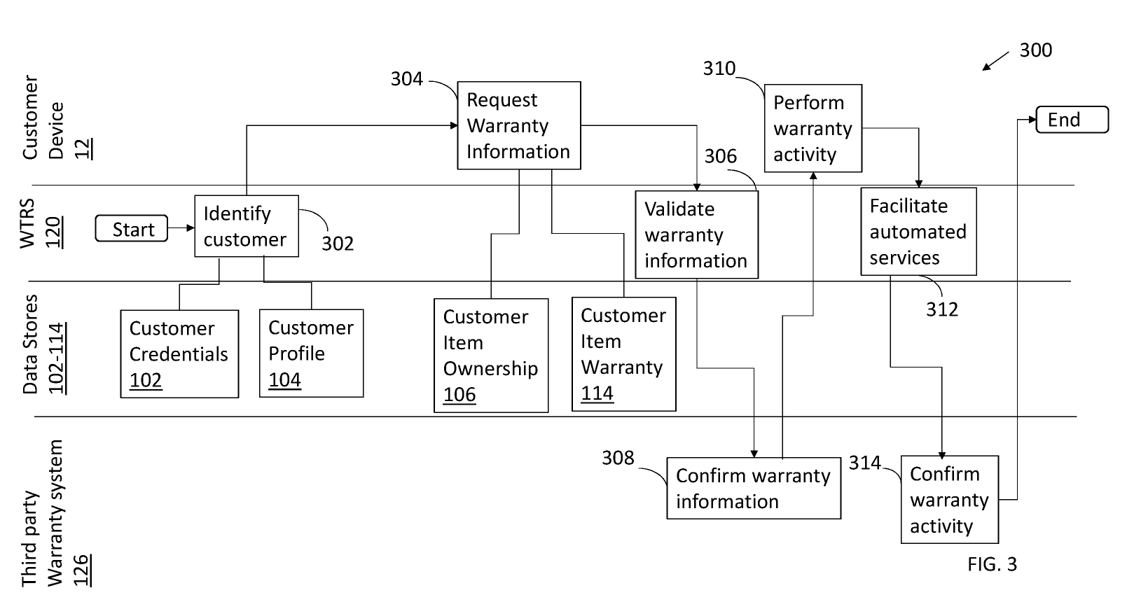

FIG. 3 is a flow diagram of a warranty process 300, in accordance with some embodiments. Some or all of the warranty process 300 can be performed at the warranty registration and tracking system (WRTS) 130 of FIG. 1, and/or other elements of the environment illustrated in FIG. 1. The warranty process 300 can be governed by instructions that are stored in a memory device of the warranty registration and tracking system 130 of FIG. 1, and/or other elements of the environment illustrated in FIG. 1, and executed by a hardware processor of the warranty registration and tracking system 130 of FIGS. 1 and 2, and/or other elements of the environment illustrated in FIG. 1.

Step 302 is similar to step 202 described with reference to the method 200 of FIG. 2. More specifically, at step 302, the warranty registration and tracking system 130 processes data from the credential data store 102 and the customer information data store 104, respectively, so that the customer can be identified.

At step 304, the customer requests warranty information. In doing so, data may be retrieved from the customer item ownership 106 and customer item warranty 114 data stores, respectively. Here, a list of items under warranty may be provided under customer item ownership data store, and warranty details may be provided from customer item warranty data store 114. Accordingly, a customer can view items under warranty, and not under warranty.

At step 306, warranty information can be validated, for example, described herein. Details are therefore not repeated due to brevity.

At step 308, the warranty information is confirmed, for example, described in step 212 above. Details are therefore not repeated due to brevity.

At step 310, warranty activity is performed.

At step 312, automated services are facilitated. For example, some items may require certain services to be performed to maintain a warranty intact. For example, tires need to be rotated every 10,000 thousand miles, oil changed on the mower every 3 months hours of service, and so on. The automated services step 312 can remind the customer via an electronic communication, automated voice message, and so on to perform such services at required times or intervals in order to preserve a current warranty on these items requiring such services.

At step 314, warranty activity is confirmed, for example, via data transfer to the third party warranty system 126.

The systems and methods in accordance with embodiments, for example, described herein allow a customer to control items purchased, automates the warranty registration process, and facilitates warranty claims and management. Warranty claims and management can be facilitated by via a system which provides relevant information in the form of web links or the like to file warranty claims. In some embodiments, a method is provided to track progress on warranty claims that have been made.

In some embodiments, the warranty registration and tracking system 130 can receive and store at a data store a facsimile or other communication of a receipt which accompanies the registration so that if a refund or replacement is required, the customer need only use the system to initiate action. When parts or associated items are not covered under the warranty, the system 130 can generate a recommendation how to obtain the parts or items through the warranty registration and tracking system 130 providing a method for purchasing the item. For example, a communication link to parts ordering may be made available.

In some embodiments, once a registration is determined, a user may proactively market replacements near the expected usefulness time frame. This is different than a well-known marketing of extended warranty coverage. For example, a customer may purchase a lawn mower requiring periodic oil changes. In an embodiment, oil filters, specific oil types, or related products may be offered, which can save the customer time in trying to determine what is needed when time to service the lawn mower.

In some embodiments, a list of registered items could be processed by the system to market extended warranty coverage especially during the expiration of the warranty.

The system 130 provides a source for the customer to review all warranty specific information from a single location, for example, a display screen of the customer's device 12. Displayed information may include warranty information for items purchased by the customer, and comparison data for comparing these items under warranty with warranty information of other items of interest, but not yet registered.

In some embodiments, the warranty registration and tracking system (WRTS) 130 can provide question and answer functionality (natural language) around “is something covered” questions. This would be useful during pre-purchase, at the point of purchase, and/or post purchase. For example, an item bar code can be scanned, and item data from the system 130 be retrieved for so that the customer can view displayed warranty coverages.

Where automation of claims is not possible, in some embodiments, the system enables the printing of any required warranty information with respect to a claim. The system may enable the printing of warranty information for any documentation the owner would like to keep on demand. A third party organizations offering warranty through a store may access, register, or opt into a program and provide an interface for performing services related to a warranty. A customer may access, register, or opt into the program to communicate with or use the cashier, a home scanner, and/or smart device to start an initial registration. If using a home scanner, the customer may use a web application for registration. If using a smart device 12, they may use a mobile application stored at and executed from the smart device 12. If using the cashier, the customer may request that the cashier enter customer-related information at a POS device. If using self-checkout, the POS device will need to ask for entry either by voice or touch screen. Once entry is made, the system may verify with the third party, for example, via the internet or other communication network, if the warranty is valid and extract any rules that will apply. The system may then return the information to the web application, mobile application, POS, or self-checkout, and provide a paper or electronic receipt with instructions on how to use, maintain, and retrieve information in the future using the customer warranty account and this system.

At any time that the customer wishes, the customer should be able to perform certain functions through the web application, mobile application, or POS. Warranty information may be retrieved from a data store 102-116, for example, described herein according to some embodiments. Warranty information and features may be maintained at a data store 102-116, for example, related to extending a warranty. In some embodiments, this information is transmitted to a third party organization. Warranty may be redeemed under agreed terms, which can likewise be recorded and stored at a data store, and transmitted to the third party organization. Here, the third party organization would need to verify the warranty terms and situation. The third party may confirm or deny warranty actions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While concepts have been shown and described with reference to specific preferred embodiments, it should be understood by those skilled in the art that various changes in form and detail may be made therein without departing from the spirit and scope as defined by the following claims.

What is claimed is:

1. A system for automating a warranty process, comprising:
a receipt scanning system;
an automated warranty claims system;
a third party warranty system;
at least one data store; and
a warranty registration and tracking system that processes data received from a combination of the receipt scanning system, the automated warranty claims system, and the third party warranty system to performing services related to a warranty.

2. The system of claim 1, wherein the warranty registration and tracking system creates from data a record that includes item warranty registration, associates information about an item with the information about the customer of the item, adds the record to a list of registered items, and stores the record at a data store of the at least one data stores.

3. The system of claim 1, wherein the record is used to facilitate a future warranty registration.

4. A method for registering an item under warranty, comprising:
performing an item warranty registration that includes associating information about an item with information about a customer of the item; and
using the information about the customer of the item for subsequent item warranty registrations.

5. The method of claim 4, further comprising:
creating and storing a record that includes the item warranty registration;
associating information about an item with the information about the customer of the item; and
adding the record to a list of registered items.

6. The method of claim 5, wherein the record is used to facilitate a future warranty registration.

7. The method of claim 4, further comprising processing a combination of the information about the item and the information about the customer of the item to perform an automated warranty process on the item.

8. The method of claim 4, further comprising
storing customer item ownership information regarding purchases made by the customer; and
using the customer item ownership information to track item sales and facilitate warranty claims.

9. The method of claim 4, further comprising:
comparing warranty coverage information and actual event data to determine whether the registered item is covered by a warranty program.

10. A warranty registration and tracking system, comprising:
an interface to a third party system for performing services related to a warranty; and
a processor that facilitates a communication between a personal electronic device and one or more data stores to perform an automated warranty process regarding the services related to the warranty on purchased store items using customer information stored at a data store of the one or more data stores.

11. The system of claim 10, wherein the interface communicates with a website or other third party system permitting the customer to perform a warranty registration process, and wherein the interface communicates with a point of sale (POS) system, web application, or other electronic device for automating the warranty registration process for application to additional warranty processes.

12. The system of claim 10, wherein the warranty registration and tracking system processes a combination of customer profile data stored at customer information data store of the data stores and credential data in a credential data store of the data stores to identify a customer of items to which one or more warranties apply.

13. The system of claim 10, wherein the warranty registration and tracking system includes a processor constructed and arranged to process a customer item warranty when a warranty is approved.

14. The system of claim 10, wherein the warranty registration and tracking system includes a processor constructed and arranged to validate warranty requirements.

15. A method for registering an item under warranty, comprising:
purchasing, by a customer, a store item;
receiving information about the customer of the store item;
associating the customer information with information about the store item, the information including store item warranty information;
creating and storing a record that includes the association between the store item warranty information and the customer information; and
using the record to facilitate a future warranty registration.

16. The method of claim 15, further comprising offering additional services by associating the purchase information and the warranty registration.

17. The method of claim 15, wherein the other warranty registration includes an extended warranty registration.

18. The method of claim 15, further comprising:
ordering a replacement part for the store item using the record, wherein the ordering information is linked to the record.

19. The method of claim 15, further comprising:
registering a purchased store item for a warranty service;
storing the initial warranty registration, wherein the record includes the association between the initial warranty registration information and information about the purchaser of the store item; and
performing another warranty registration using the record.

20. The method of claim 19, wherein registering the purchased store item for a warranty service comprises scanning a barcode at a cashier register or other location such as a doorway or basket or transferring standard warranty information through a smart device, or comprises scanning RFID chips or optical recognition of the store items a barcode at a cashier register or other location such as a doorway or basket or transferring standard warranty information through a smart device.
